(19) United States
(12) Patent Application Publication
(10) Pub. No.: US 2026/0077396 A1
(43) Pub. Date: Mar. 19, 2026

(54) SYSTEM AND METHOD FOR CAPTURING AND STABILIZING FOOD WASTE STREAMS

(71) Applicant: Timothy Childs, San Francisco, CA (US)

(72) Inventor: Timothy Childs, San Francisco, CA (US)

(21) Appl. No.: 19/329,465

(22) Filed: Sep. 15, 2025

Related U.S. Application Data
(60) Provisional application No. 63/695,240, filed on Sep. 16, 2024.

(51) Int. Cl. B09B 3/40; B09B 101/70

(52) U.S. Cl. CPC B09B 3/40; B09B 2101/70

(57) ABSTRACT

The present invention is a quick-freeze and chill system for capturing and stabilizing food waste streams. The system, named “Chillin8tor,” utilizes a modified combo chiller with cryogenic gas snow horns (e.g., CO2, nitrogen) to rapidly and uniformly freeze or chill various food by-products and waste streams. The invention provides quick stabilization of materials for further processing or utilization across various channels including retail and post-production side streams. The system is scalable, customizable, and can be deployed in various settings. Advanced AI-driven controls optimize the freezing process, adapting to varying input conditions.

### CROSS REFERENCE TO RELATED APPLICATIONS

This application claims the benefit of U.S. Provisional Patent Application Ser. No. 63/695,240 filed Sep. 16, 2024, the contents of which are incorporated herein by reference in its entirety.

### BACKGROUND OF THE INVENTION

Approximately 40% of grown food is wasted globally. One of the largest barriers to utilizing this waste is the lack of effective stabilization methods, including seasonal crops and short production windows, as well as post-production streams that are continuously generated. Current methods often result in slow freezing, leading to fermentation and spoilage, especially in large bins where the center mass can take weeks to freeze completely.

Traditional freezing methods struggle with uniform freezing of large volumes, rapid stabilization of warm, fermentation-prone materials, maintaining nutritional value and quality during the freezing process, and cost-effective processing of varied waste streams.

Additionally, changing legislative conditions in Europe and the United States are requiring corporations to make climate and carbon commitments, including better management of food waste. For example, EU and California legislation is forcing grocery retailers to find alternatives to throwing away food, mandating that they must do something productive with it. This invention addresses these challenges and provides a solution to one of the biggest problems in the food upcycling supply chain.

Current methods for stabilizing food waste streams often involve manual processes that are inefficient and prone to error. For instance, in some operations, workers manually shovel dry ice (solid CO2) into bins as waste material. This approach has several drawbacks including, and not by means of limitation: uneven distribution of cryogenic material resulting in inconsistent cooling with hot and cold spots throughout the material, inconsistent freezing leading to partial fermentation of the waste stream, reducing overall quality and usability, variations in the flow rate of incoming material (e.g., from large wine presses) making it difficult for workers to apply the correct amount of cryogenic material, leading to either inadequate freezing or wasteful overuse of coolant, and manual labor is intensive and can be inconsistent, leading to variability in the quality of the stabilized product. These issues often result in wasted products, increased labor costs, and inefficient use of cooling resources.

Moreover, recent studies have shown that many food side streams and waste products often contain higher concentrations of beneficial compounds than the primary products. These include fiber that promotes gut health, bound antioxidants, and other nutraceutical compounds. In the case of fresh produce from farmers or growers, the point at which it becomes considered “waste” often coincides with peak ripeness and flavor development. Traditional waste management methods fail to capture these nutritional and flavor benefits, representing a significant loss of potential value.

Currently, there are no existing solutions to address the above drawbacks associated with food stabilization methods that specifically use cryogenic or quick chill systems for stabilizing food waste streams. While some systems have attempted to address the above concerns, they have not been specifically applied to the rapid stabilization of food waste streams. The current invention uniquely combines and adapts existing technologies in cryogenic cooling, material conveyance, and rapid freezing to address the specific challenges of food waste management and upcycling.

### SUMMARY OF THE INVENTION

The present invention pertains to a novel quick freeze and chilling system designed to capture and stabilize fragile post-production, retail, food service, distribution, farmers or growers, and producer side streams or waste products. This system enables rapid freezing or chilling of materials from various points in the food supply chain for immediate use or later processing, either nearby or at distant locations.

This system is particularly valuable for preserving the often-overlooked nutritional benefits of food side streams and waste. Many of these streams contain higher concentrations of beneficial compounds, including fiber for gut health and bound antioxidants, than the primary products they derive from. Furthermore, in the case of fresh produce, the system can capture and preserve the peak flavor and nutritional profiles that often coincide with the point at which the produce would traditionally be discarded as waste.

Key features of the invention include rapid and uniform chilling or freezing of food waste streams, utilization of a modified “combo chiller” technology which uses cryogenic gas snow horns for layered freezing (e.g., with solid CO2 or nitrogen), optional incorporation of a pre-chilling conveyance system, pH modification for enhanced food stability (when using CO2), scalable design for various operational needs, optional integrated weight and temperature monitoring, optional advanced AI-driven control system for process optimization and self-adjustment, and flexibility in cryogenic gas selection to optimize for specific product requirements and operational conditions. The present invention also increases food safety by eliminating potential pathogen contamination from manual workers.

The system's AI capabilities feature core control functions that manage the freezing process, which integrates data from the temperature control, scale, and automated systems. The present invention employs artificial intelligence algorithms to continuously optimize the freezing process. Given the loadings of historical uses, the AI system can make suggestions on where to start for new materials coming in, which reduces the need for human interference and lessens the likelihood of human error. The present invention automatically adapts system parameters based on real-time data and historical performance. The present invention anticipates changes in input material characteristics or flow rates and preemptively adjusts the system. The present invention improves system performance over time by learning from past operations and outcomes.

The invention incorporates a set of temperature probes arranged in a matrix (for example, in a 3×3, 4×4 alignment), each with measurements at the tip, middle, and top, or other combinations, which creates a three-dimensional temperature map when inserted into finished bins, allowing measurement of the freeze rate and uniformity.

The system addresses the critical need for quick, cost-effective stabilization of food waste streams, which enables the capture of nutritional and commercial value from materials that would otherwise be lost.

The system can be used for myriad materials and processes that provide essential technical, environmental, societal and economic benefits, including, and not by means of limitation: stabilizing various food processing by-products; wine pomace; beer waste; juice pulp; distilled grain; nut and seed press cake; other production side streams such as tofu, pea protein extraction, hemp/cannabis extraction, etc.; preserving food waste from retail, food service, production and distribution channels; overstocked fresh produce from retail stores; unsold or excess inventory from grocery stores; unused ingredients and prepared foods from restaurants and food service operations; surplus crops at the grower level; excess inventory at distribution centers; processing materials with varying freezing requirements due to different compositions; creating frozen products for direct sale or donation; preparing materials for subsequent processes; freeze-drying; pureeing; powder production; pre-step for supercritical extraction processes, reducing CO2 costs by pre-chilling material; stabilizing streams from meat, poultry, dairy, and fish operations; reducing overall processing costs by quickly chilling products before refrigeration; meeting regulatory requirements for waste utilization in retail, distribution, and food service operations; on-site processing at supermarkets, food processors, restaurants, and other locations with limited operational space; seasonal crop preservation during short harvest windows or periods of overproduction; and stabilizing unsold or excess inventory throughout the food supply chain to extend usability and reduce waste.

Furthermore, this quick-freezing process provides significant advantages in downstream processing. Unlike traditional methods that result in large, solid frozen blocks requiring specialized equipment to break apart, this system produces individually quick-frozen particles or pieces. This allows the stabilized material to be easily poured, dumped and measured, much like commercially frozen vegetables. As a result, it eliminates the need for food-safe jackhammers, block chippers, or breakers, significantly reducing the complexity, cost, time, and requirement for particle size reduction or product size reduction involved in subsequent processing steps.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 illustrates the Chillin8tor chamber in an open state.

FIG. 2 illustrates the Chillin8tor conveyance system positioned over top of the Chillin8tor to illustrate secondary input mechanism potential.

FIG. 3 is a diagram illustrating how the component parts of the Chillin8tor may interact with one another when freezing or chilling food waste.

FIG. 4 is a diagram illustrating the process of freezing or chilling food waste with the Chillin8tor.

### DETAILED DESCRIPTION OF THE PREFERRED EMBODIMENT

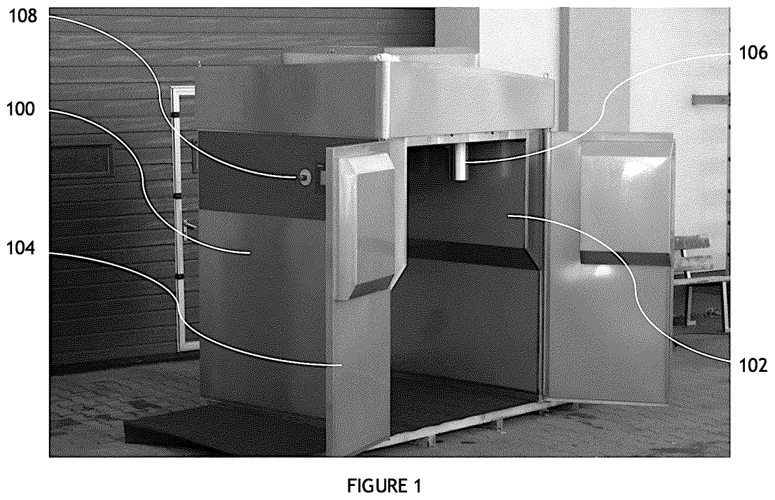

FIG. 1 shows the physical embodiment of the invention used for freezing or chilling food waste streams comprising a modified combo chiller 100, main freezing chamber 102, sensors for monitoring inbound material, ambient air, and processed material temperatures 104, one or more cryogenic gas snow horns capable of using various cryogenic gases such as CO2 or nitrogen 106, a control system for managing the freezing process 108, and an inbound conveyance system. The invention features optional temperature control 108 that allows a user to utilize the invention in a customized way that satisfies the user's needs and allows the user to precisely manage the freezing process.

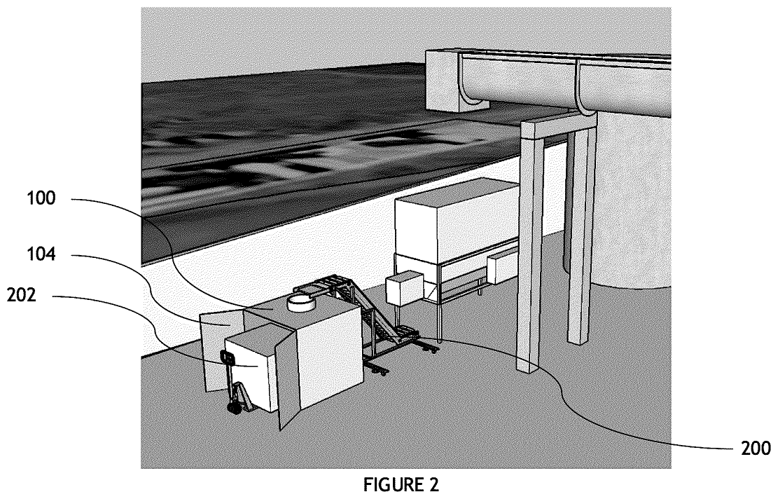

FIG. 2 shows the inbound conveyance system comprising temperature sensors for monitoring ambient air and material temperatures 104, wherein the system includes pre-chilling capabilities using cryogenic liquid or other refrigerated processes. The system in FIG. 2 engages in a method for stabilizing food waste streams comprising conveying food waste material 202 into a main freezing chamber 102 by mechanical, magnetic, gravitational, pneumatic or other means. The system applies layers of cryogenic snow, gas, or liquid to the material as it enters the main freezing chamber 102 with or without controlled atmospheric pressures (negative or positive), with or without any other electromechanical conditioning such as microwave, ultrasonic, etc.

The system allows the food waste material 202 to be frozen or chilled within the chamber and to maintain its state when it leaves the chamber. The method comprises altering the pH of the food waste material 202 through the application of CO2 snow when CO2 is used as the cryogenic gas, with considerations for food safety impacts of pH alteration. The method contains the food waste material 202 of one or more of the following: wine pomace, beer waste, juice pulp, distilled grains, nut and seed press cake, other food processing by-products, or whole pieces of fruits and vegetables from retail operations. The invention features an inbound conveyance system that can be configured with or without using the chilling capabilities. The invention features an automated push system that facilitates the movement of frozen material out of the quick chill box, enabling continuous or batch processing depending on the specific needs of the user.

Further, the systems in FIGS. 1 and 2 integrate a mobile system for on-site freezing of food waste streams, comprising the invention integrated into a transportable unit. The invention further comprises a surge hopper 201 for regulating the inflow of material to ensure consistent feed rate.

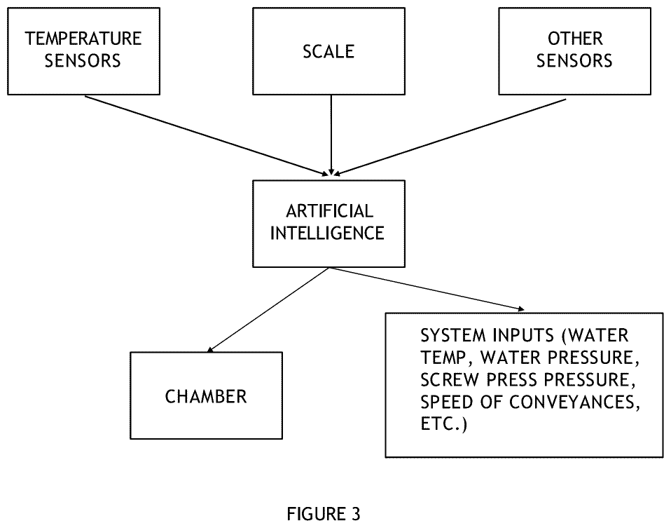

FIG. 3 shows how the comprising parts of the invention may interact with one another to produce the desired output. Within the modified combo chiller 100, the temperature sensors, scale, and other sensors may be used. They may then employ artificial intelligence which may then prompt the actions of the chiller 100, which may then freeze or chill the food waste material 202 within the main freezing chamber 102 and may then create the frozen or chilled food waste streams. The artificial intelligence also generates control outputs that regulate key system parameters, including water temperature, water pressure, screw press pressure, speed of conveyances, and other operational conditions.

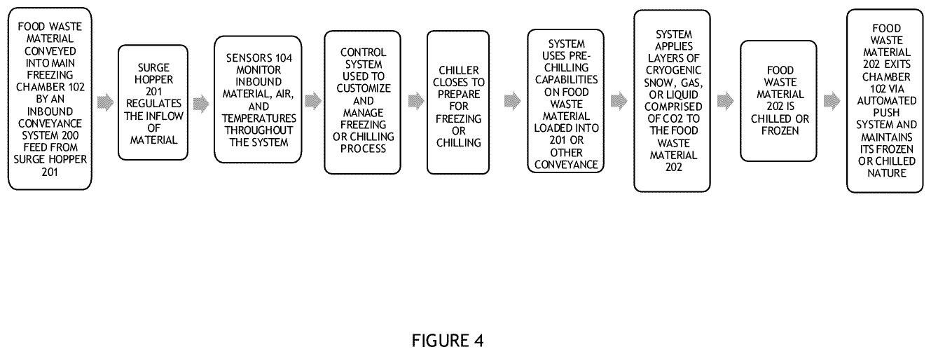

FIG. 4 shows the process of freezing or chilling food waste streams with the Chillin8tor. The food waste material 202 may be conveyed into a main freezing chamber 102 by an inbound conveyance system 200 feed from surge hopper 201 by mechanical, magnetic, gravitational, pneumatic or other means. The invention may use a surge hopper 201 to regulate the inflow of material to ensure consistent feed rate. The sensors 104 may monitor the inbound material, ambient air, and processed material temperatures throughout the system. Water can be applied to any of these stages before chilling. The control system 108, comprised in part with an optional temperature control, may be used by the user to customize and manage the freezing or chilling process to the needs of the user. The modified combo chiller 100 may be closed so that the main freezing chamber 102 is prepared for the freezing or chilling process to begin. The system may have pre-chilling capabilities using cryogenic liquid or other refrigerated processes that it can use on the food waste material 202 loaded into 201 or other conveyance. The system may then apply layers of cryogenic snow, gas, or liquid comprised of CO2 to the food waste material 202 with or without controlled atmospheric pressures (negative or positive), with or without any other electromechanical conditioning. The food waste material 202 may then be chilled or frozen. As the food waste material 202 exits the chamber via the automated push system, it may maintain its frozen or chilled nature.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A system for stabilizing food waste streams, comprising:
a surge hopper configured to regulate an inflow of food waste material into an inbound conveyance system, said inbound conveyance system operable to transport the food waste material into a main freezing chamber;
one or more cryogenic delivery devices configured to apply a cryogenic medium to the food waste material within the main freezing chamber;
a plurality of sensors configured to monitor conditions of the food waste material and system environment; and
a control system comprising artificial intelligence algorithms, the control system operable to receive input from the sensors and adjust operating parameters of the system to achieve rapid and uniform freezing or chilling of the food waste material.

2. The system of claim 1, wherein the cryogenic medium comprises carbon dioxide, nitrogen, or combinations thereof.

3. The system of claim 1, wherein the plurality of sensors comprise temperature probes arranged in a matrix configuration to provide a three-dimensional temperature map of the food waste material.

4. The system of claim 1, wherein the stabilized food waste material is discharged from the main freezing chamber in the form of individually frozen particles.
